(19) United States
(12) Patent Application Publication
(10) Pub. No.: US 2008/0113717 A1
(43) Pub. Date: May 15, 2008

(54) Gaming apparatus and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/798,121

(22) Filed: May 10, 2007

Related U.S. Application Data
(60) Provisional application No. 60/858,940, filed on Nov. 15, 2006.

(51) Int. Cl. A63F 13/10

(52) U.S. Cl. 463/17; 273/142 E

(57) ABSTRACT

The roulette game is proceeded while controlling such that a probability of having a ball fell into a pocket provided on a roulette wheel becomes relatively higher at a specific pocket among a plurality of pockets, sizes of prizes generated at the specific pocket are accumulated, and the specific pocket is changed to another pocket among the plurality of pockets in a case where that accumulated result reached to a threshold.

### CROSS-REFERENCE TO RELATED APPLICATION

This application is based upon and claims the benefit of U.S. Provisional Application No. 60/858,940, filed on Nov. 15, 2006; the entire contents of which are incorporated herein by reference.

### BACKGROUND OF THE INVENTION

1. Field of the Invention

The present invention relates to a gaming apparatus such as a roulette game machine and a playing method thereof.

2. Description of the Related Art

Conventionally, in the roulette game, it has been customary to play the game as a ball is entered onto a roulette wheel by a dealer, but in recent years, due to the advance of the automation, there has been a proposition of a gaming apparatus which proceeds the roulette game fully automatically, without requiring a dealer to enter the ball.

Among such gaming apparatuses, there exists a gaming apparatus which launches the ball by the air as disclosed in the International Patent Publication WO2004/094013. In the gaming apparatus which can proceeds the roulette game fully automatically, it is considered preferable to have the ball fell and accommodated into each pocket at a uniform probability. For this reason, among such gaming apparatuses, there exists one that is designed to disturb the behavior of the ball by providing concavity and convexity on a surface of a ball track such that the ball will fall into each pocket at a uniform probability.

The present invention has an object of providing a gaming apparatus and a playing method of a gaming apparatus which are provided with new entertainment characteristics.

### SUMMARY OF THE INVENTION

The first aspect of the present invention is a gaming apparatus comprising: a roulette wheel having a plurality of pockets; a device for launching a ball into the roulette wheel; a detection unit for detecting a pocket into which the ball fell; a controller operable to execute a first control for controlling such that a probability of having the ball fell into the pocket becomes relatively higher at a specific pocket among the plurality of pockets, and execute a second control for accumulating sizes of prizes generated at the specific pocket among prizes generated according to a detection result of the detection unit, and changing the specific pocket to another pocket among the plurality of pockets in a case where that accumulated result reached to a threshold. In this gaming apparatus, the game proceeds while setting a specific pocket into which a probability of having the ball fell is relatively high. Then, the specific pocket is changed to another pocket in a case where sizes of prizes generated at the specific pocket reached to a threshold.

The second aspect of the present invention is a gaming apparatus comprising: a roulette wheel having a plurality of pockets; a device for launching a ball into the roulette wheel; a detection unit for detecting a pocket into which the ball fell; a controller operable to execute a first control for controlling such that a probability of having the ball fell into the pocket becomes relatively higher at a specific group among a plurality of groups formed by dividing the plurality of pockets into groups of two or more pockets, and execute a second control for accumulating sizes of prizes generated at the specific group among prizes generated according to a detection result of the detection unit, and changing the specific group to another group among the plurality of groups in a case where that accumulated result reached to a threshold. In this gaming apparatus, the game proceeds while setting a specific group having a plurality of pockets into which a probability of having the ball fell is relatively high. Then, the specific group is changed to another group in a case where sizes of prizes generated at the specific group reached to a threshold.

The third aspect of the present invention is a gaming apparatus comprising: a roulette wheel having a plurality of pockets; a device for launching a ball into the roulette wheel; a detection unit for detecting a pocket into which the ball fell; a controller operable to execute a first control for controlling such that a probability of having the ball fell into the pocket becomes relatively higher at a specific pocket among the plurality of pockets, execute a processing for accepting a bet with respect to at least one pocket among the plurality of pockets by each player, and execute a second control for accumulating sizes of prizes generated at the specific pocket among prizes generated according to a detection result of the detection unit and the bet of each player, and changing the specific pocket to another pocket among the plurality of pockets in a case where that accumulated result for at least one player reached to a threshold. In this gaming apparatus, the game proceeds while setting a specific pocket into which a probability of having the ball fell is relatively high. Then, the specific pocket is changed to another pocket in a case where sizes of prizes generated at the specific pocket for at least one player reached to a threshold.

The fourth aspect of the present invention is a gaming apparatus comprising: a roulette wheel having a plurality of pockets; a device for launching a ball into the roulette wheel; a detection unit for detecting a pocket into which the ball fell; a controller operable to execute a first control for controlling such that a probability of having the ball fell into the pocket becomes relatively higher at a specific group among a plurality of groups formed by dividing the plurality of pockets into groups of two or more pockets, execute a processing for accepting a bet with respect to at least one pocket among the plurality of pockets by each player, and execute a second control for accumulating sizes of prizes generated at the specific group among prizes generated according to a detection result of the detection unit and the bet of each player, and changing the specific group to another group among the plurality of groups in a case where that accumulated result for at least one player reached to a threshold. In this gaming apparatus, the game proceeds while setting a specific group having a plurality of pockets into which a probability of having the ball fell is relatively high. Then, the specific group is changed to another group in a case where sizes of prizes generated at the specific group for at least one player reached to a threshold.

The fifth aspect of the present invention is a gaming apparatus comprising: a roulette wheel having a plurality of pockets and supported to be freely rotatable; a rotation driving unit for rotating the roulette wheel; a device for launching a ball into the roulette wheel; a detection unit for detecting a pocket into which the ball fell; a controller operable to execute a first control for controlling such that a probability of having the ball fell into the pocket becomes relatively higher at a specific pocket among the plurality of pockets by controlling at least one selected from a speed of a rotation, a speed for launching the ball, and a timing for launching the ball, and execute a second control for accumulating sizes of prizes generated at the specific pocket among prizes generated according to a detection result of the detection unit, and changing the specific pocket to another pocket among the plurality of pockets in a case where that accumulated result reached to a threshold. In this gaming apparatus, the probability of having the ball fell becomes relatively high for a specific pocket by controlling at least one selected from a speed of a rotation, a speed for launching the ball, and a timing for launching the ball. Then, the specific pocket is changed to another pocket in a case where sizes of prizes generated at the specific pocket reached to a threshold.

The sixth aspect of the present invention is a gaming apparatus comprising: a roulette wheel having a plurality of pockets and supported to be freely rotatable; a rotation driving unit for rotating the roulette wheel; a device for launching a ball into the roulette wheel; a detection unit for detecting a pocket into which the ball fell; a controller operable to execute a first control for controlling such that a probability of having the ball fell into the pocket becomes relatively higher at a specific group among a plurality of groups formed by dividing the plurality of pockets into groups of two or more pockets by controlling at least one selected from a speed of a rotation, a speed for launching the ball, and a timing for launching the ball, and execute a second control for accumulating sizes of prizes generated at the specific group among prizes generated according to a detection result of the detection unit, and changing the specific group to another group among the plurality of groups in a case where that accumulated result reached to a threshold. In this gaming apparatus, the probability of having the ball fell becomes relatively high for a specific group having a plurality of pockets by controlling at least one selected from a speed of a rotation, a speed for launching the ball, and a timing for launching the ball. Then, the specific group is changed to another group in a case where sizes of prizes generated at the specific group reached to a threshold.

The seventh aspect of the present invention is a gaming apparatus comprising: a roulette wheel having a plurality of pockets and supported to be freely rotatable; a rotation driving unit for rotating the roulette wheel; a device for launching a ball into the roulette wheel; a detection unit for detecting a pocket into which the ball fell; a controller operable to execute a first control for controlling such that a probability of having the ball fell into the pocket becomes relatively higher at a specific pocket among the plurality of pockets by controlling at least one selected from a speed of a rotation, a speed for launching the ball, and a timing for launching the ball, a processing for accepting a bet with respect to at least one pocket among the plurality of pockets by each player, and execute a second control for accumulating sizes of prizes generated at the specific pocket for each player among prizes generated according to a detection result of the detection unit and the bet of each player, and changing the specific pocket to another pocket among the plurality of pockets in a case where that accumulated result for at least one player reached to a threshold. In this gaming apparatus, the probability of having the ball fell becomes relatively high for a specific pocket by controlling at least one selected from a speed of a rotation, a speed for launching the ball, and a timing for launching the ball. Then, the specific pocket is changed to another pocket in a case where sizes of prizes generated at the specific pocket for at least one player reached to a threshold.

The eighth aspect of the present invention is a gaming apparatus comprising: a roulette wheel having a plurality of pockets and supported to be freely rotatable; a rotation driving unit for rotating the roulette wheel; a device for launching a ball into the roulette wheel; a detection unit for detecting a pocket into which the ball fell; a controller operable to execute a first control for controlling such that a probability of having the ball fell into the pocket becomes relatively higher at a specific group among a plurality of groups formed by dividing the plurality of pockets into groups of two or more pockets by controlling at least one selected from a speed of a rotation, a speed for launching the ball, and a timing for launching the ball, execute a processing for accepting a bet with respect to at least one pocket among the plurality of pockets by each player, and execute a second control for accumulating sizes of prizes generated at the specific group among prizes generated according to a detection result of the detection unit and the bet of each player, and changing the specific group to another group among the plurality of groups in a case where that accumulated result for at least one player reached to a threshold. In this gaming apparatus, the probability of having the ball fell becomes relatively high for a specific group having a plurality of pockets by controlling at least one selected from a speed of a rotation, a speed for launching the ball, and a timing for launching the ball. Then, the specific group is changed to another group in a case where sizes of prizes generated at the specific group for at least one player reached to a threshold.

The ninth aspect of the present invention is a playing method of a gaming apparatus, comprising the steps of: proceeding with a roulette game in which a ball is launched into a roulette wheel provided with a plurality of pockets and a prize according to a pocket into which the ball fell is generated; controlling such that a probability of having the ball fell into the pocket becomes relatively higher at a specific pocket among the plurality of pockets; accumulating sizes of prizes generated at the specific pocket; and changing the specific pocket to another pocket among the plurality of pockets in a case where that accumulated result reached to a threshold. In this, playing method of a gaming apparatus, the game proceeds while setting a specific pocket into which a probability of having the ball fell is relatively high. Then, the specific pocket is changed to another pocket in a case where sizes of prizes generated at the specific pocket reached to a threshold.

The tenth aspect of the present invention is a playing method of a gaming apparatus, comprising the steps of: proceeding with a roulette game in which a ball is launched into a roulette wheel provided with a plurality of pockets and a prize according to a pocket into which the ball fell is generated; controlling such that a probability of having the ball fell into the pocket becomes relatively higher at a specific group among a plurality of groups formed by dividing the plurality of pockets into groups of two or more pockets; accumulating sizes of prizes generated at the specific group; and changing the specific group to another group among the plurality of groups in a case where that accumulated result reached to a threshold. In this playing method of a gaming apparatus, the game proceeds while setting a specific group having a plurality of pockets into which a probability of having the ball fell is relatively high. Then, the specific group is changed to another group in a case where sizes of prizes generated at the specific group reached to a threshold.

The eleventh aspect of the present invention is a playing method of a gaming apparatus, comprising the steps of: proceeding with a roulette game in which a ball is launched into a roulette wheel provided with a plurality of pockets and a prize is generated on a condition that the ball fell into a pocket on which a bet is made in advance among the plurality of pockets; controlling such that a probability of having the ball fell into the pocket becomes relatively higher at a specific pocket among the plurality of pockets; accepting a bet with respect to at least one pocket among the plurality of pockets by each player; accumulating sizes of prizes generated at the specific pocket; and changing the specific pocket to another pocket among the plurality of pockets in a case where that accumulated result for at least one player reached to a threshold. In this playing method of a gaming apparatus, the game proceeds while setting a specific pocket into which a probability of having the ball fell is relatively high. Then, the specific pocket is changed to another pocket in a case where sizes of prizes generated at the specific pocket for at least one player reached to a threshold.

The twelfth aspect of the present invention is a playing method of a gaming apparatus, comprising the steps of: proceeding with a roulette game in which a ball is launched into a roulette wheel provided with a plurality of pockets and a prize is generated on a condition that the ball fell into a pocket on which a bet is made in advance among the plurality of pockets; controlling such that a probability of having the ball fell into the pocket becomes relatively higher at a specific group among a plurality of groups formed by dividing the plurality of pockets into groups of two or more pockets; accepting a bet with respect to at least one pocket among the plurality of pockets by each player; accumulating sizes of prizes generated at the specific group; and changing the specific group to another group among the plurality of groups in a case where that accumulated result for at least one player reached to a threshold. In this playing method of a gaming apparatus, the game proceeds while setting a specific group having a plurality of pockets into which a probability of having the ball fell is relatively high. Then, the specific group is changed to another group in a case where sizes of prizes generated at the specific group for at least one player reached to a threshold.

The thirteenth aspect of the present invention is a playing method of a gaming apparatus, comprising the steps of: proceeding with a roulette game in which a roulette wheel provided with a plurality of pockets is rotated while a ball is launched into the roulette wheel, and a prize according to a pocket into which the ball fell is generated; controlling such that a probability of having the ball fell into the pocket becomes relatively higher at a specific pocket among the plurality of pockets by controlling at least one selected from a speed of a rotation, a speed for launching the ball, and a timing for launching the ball; accumulating sizes of prizes generated at the specific pocket; and changing the specific pocket to another pocket among the plurality of pockets in a case where that accumulated result reached to a threshold. In this playing method of a gaming apparatus, the probability of having the ball fell becomes relatively high for a specific pocket by controlling at least one selected from a speed of a rotation, a speed for launching the ball, and a timing for launching the ball. Then, the specific pocket is changed to another pocket in a case where sizes of prizes generated at the specific pocket reached to a threshold.

The fourteenth aspect of the present invention is a playing method of a gaming apparatus, comprising the steps of: proceeding with a roulette game in which a roulette wheel provided with a plurality of pockets is rotated while a ball is launched into the roulette wheel, and a prize according to a pocket into which the ball fell is generated; controlling such that a probability of having the ball fell into the pocket becomes relatively higher at a specific group among a plurality of groups formed by dividing the plurality of pockets into groups of two or more pockets by controlling at least one selected from a speed of a rotation, a speed for launching the ball, and a timing for launching the ball; accumulating sizes of prizes generated at the specific group; and changing the specific group to another group among the plurality of groups in a case where that accumulated result reached to a threshold. In this playing method of a gaming apparatus, the probability of having the ball fell becomes relatively high for a specific group having a plurality of pockets by controlling at least one selected from a speed of a rotation, a speed for launching the ball, and a timing for launching the ball. Then, the specific group is changed to another group in a case where sizes of prizes generated at the specific group reached to a threshold.

The fifteenth aspect of the present invention is a playing method of a gaming apparatus, comprising the steps of: proceeding with a roulette game in which a roulette wheel provided with a plurality of pockets is rotated while a ball is launched into the roulette wheel, a and a prize is generated on a condition that the ball fell into a pocket on which a bet is made in advance among the plurality of pockets; controlling such that a probability of having the ball fell into the pocket becomes relatively higher at a specific pocket among the plurality of pockets by controlling at least one selected from a speed of a rotation, a speed for launching the ball, and a timing for launching the ball; accepting a bet with respect to at least one pocket among the plurality of pockets by each player; accumulating sizes of prizes generated at the specific pocket; and changing the specific pocket to another pocket among the plurality of pockets in a case where that accumulated result for at least one player reached to a threshold. In this playing method of a gaming apparatus, the probability of having the ball fell becomes relatively high for a specific pocket by controlling at least one selected from a speed of a rotation, a speed for launching the ball, and a timing for launching the ball. Then, the specific pocket is changed to another pocket in a case where sizes of prizes generated at the specific pocket for at least one player reached to a threshold.

The sixteenth aspect of the present invention is a playing method of a gaming apparatus, comprising the steps of: proceeding with a roulette game in which a roulette wheel provided with a plurality of pockets while a ball is launched into the roulette wheel, and a prize is generated on a condition that the ball fell into a pocket on which a bet is made in advance among the plurality of pockets; controlling such that a probability of having the ball fell into the pocket becomes relatively higher at a specific group among a plurality of groups formed by dividing the plurality of pockets into groups of two or more pockets by controlling at least one selected from a speed of a rotation, a speed for launching the ball, and a timing for launching the ball; accepting a bet with respect to at least one pocket among the plurality of pockets by each player; accumulating sizes of prizes generated at the specific group; and changing the specific group to another group among the plurality of groups in a case where that accumulated result for at least one player reached to a threshold. In this playing method of a gaming apparatus, the probability of having the ball fell becomes relatively high for a specific group having a plurality of pockets by controlling at least one selected from a speed of a rotation, a speed for launching the ball, and a timing for launching the ball. Then, the specific group is changed to another group in a case where sizes of prizes generated at the specific group for at least one player reached to a threshold.

### BRIEF DESCRIPTION OF THE DRAWINGS

FIG. 1 is a flow chart showing a playing method of a gaming apparatus according to an embodiment of the present invention.

FIG. 2 is a diagram showing a plan view of a roulette device according to the present embodiment.

FIG. 3 is a diagram showing one example of a control data.

FIG. 4 is a diagram showing one example of a region data.

FIG. 5 is a diagram showing a perspective view of an outward appearance of a schematic configuration of a roulette game machine according to the present embodiment.

FIG. 6 is a schematic diagram showing one example of an image to be displayed on an image display device.

FIG. 7 is a block diagram showing an internal configuration of a roulette game machine according to the present embodiment.

FIG. 8 is a schematic diagram showing a memory region of a ROM of a roulette game machine according to the present embodiment.

FIG. 9 is a schematic diagram showing a memory region of a RAM of a roulette game machine according to the present embodiment.

FIG. 10 is block diagram showing an internal configuration of a roulette device according to the present embodiment.

FIG. 11 is a schematic diagram showing a memory region of a ROM of a roulette device according to the present embodiment.

FIG. 12 is a block diagram showing an internal configuration of a station according to the present embodiment.

FIG. 13 is a flow chart showing a processing procedure to be executed in proceeding a game by a roulette game machine according to the present embodiment.

FIG. 14 is a flow chart showing a processing procedure to be executed in proceeding a game by a roulette game machine according to the present embodiment.

FIG. 15 is a flow chart showing a processing procedure to be executed in proceeding a game by a roulette device of a roulette game machine according to the present embodiment.

FIG. 16 is a schematic diagram showing data to be stored in a payout amount memory area of a RAM in another embodiment.

FIG. 17 is a schematic diagram showing data to be stored in an accumulated value information memory area of a RAM in another embodiment.

### DETAILED DESCRIPTION OF THE EMBODIMENT

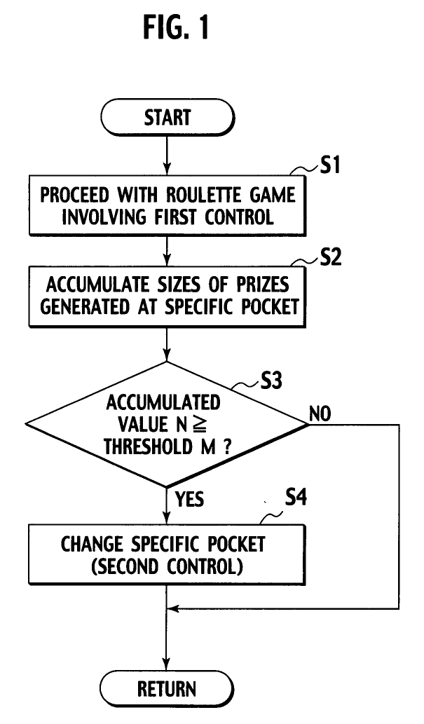

FIG. 1 is a flow chart schematically showing a playing method of a gaming apparatus according to an embodiment. In the following, the schematic operation of the gaming apparatus and its playing method will be described with reference to the flow chart shown in FIG. 1.

As shown in FIG. 1, a roulette game machine which is the gaming apparatus of the present embodiment proceeds with a roulette game involving a first control at the step S1. In this first control, the roulette game machine controls such that a probability of having a ball fell into a pocket of a roulette wheel becomes relatively higher at a specific pocket among a plurality of pockets provided on the roulette wheel. In conjunction with such a first control, the roulette game machine launches a ball into the roulette wheel, and generates a prize according to a pocket into which the ball fell.

Then, at the step S2, the roulette game machine accumulates sizes of prizes generated at the specific pocket. In this way, the accumulated value of the sizes of the prizes generated at the specific pocket is calculated for each game.

In addition, at the step S3, the roulette game machine judges whether a result of accumulating (accumulated value N) at the step S2 described above has reached to a threshold M that is set up in advance or not. When a negative result is obtained at this step S3, it implies that the accumulated value N of the sizes of the prizes accumulated for each game has not reached to the threshold M, so that the roulette game machine proceeds to a next roulette game.

On the other hand, when an affirmative result is obtained at the step S3, it implies that the accumulated value N has reached to the threshold M, so that the roulette game machine proceeds from the step S3 to the step S4 and changes the specific pocket (second control). Namely, in this second control, the roulette game machine sets another pocket as a new specific pocket instead of the pocket that has been set as the specific pocket until then (second control), and proceeds to a next game.

In this way, in the case where the accumulated value N of the sizes of the prizes generated at the specific pocket reached to the threshold M, the specific pocket is changed to another pocket, so that the sizes of the prizes generated at each pocket become uniform as the game proceeds.

Note that it is possible to set up a plurality of specific pockets, and in such a case, a specific group is formed by a plurality of specific pockets. In the case where the specific group is formed, a control for making it more likely for the ball to fall into pockets constituting that group is carried out for each such specific group. The roulette game machine accumulates the sizes of the prizes generated at any of the pockets constituting the specific group, and changes the specific group to another group when this accumulated result reached to the threshold.

Note that the processing shown in FIG. 1 is executed as a control unit of the roulette game machine and a server carry out communications. The gaming apparatus (roulette game machine) according to the present embodiment is a concept that includes the control unit and the server. In the following description, the case where the server is built-in inside the roulette game will be described, but the server may be connected to an external of the roulette game machine through a network, for example. Also, the server and the control unit may be provided in an integrated form.

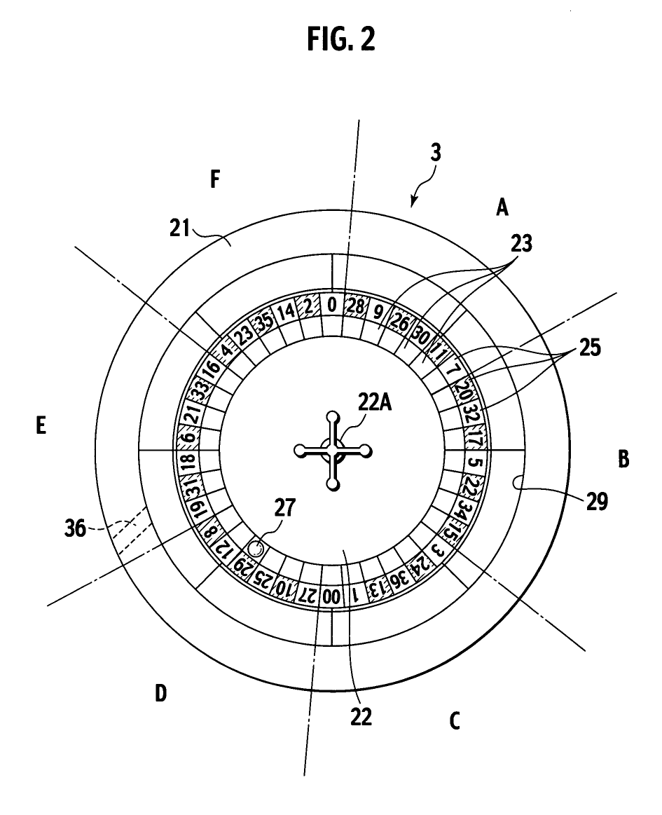

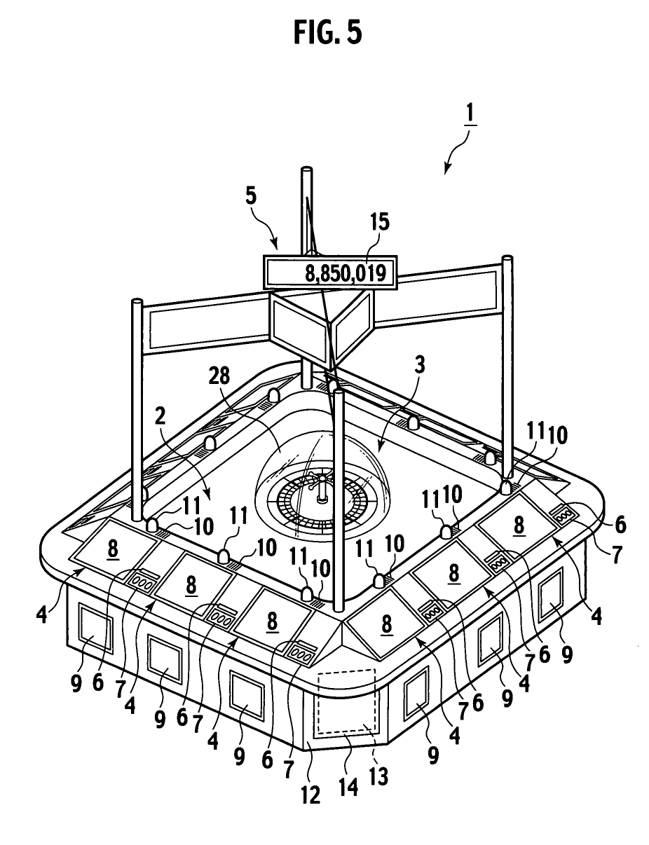

FIG. 2 is a plan view of a roulette device 3 contained in a roulette game machine 1 according to the present embodiment. FIG. 5 is a diagram showing a perspective view of an outward appearance of a schematic configuration of a roulette game machine according to the present embodiment. Note that the roulette game machine 1 is a stand-alone type gaming apparatus that is not connected to a network, but it may be provided in a form of a gaming apparatus that is connected to a network.

As shown in FIG. 2, the roulette device 3 has a frame body 21 and a roulette wheel 22. The frame body 21 is fixed to a casing 2 (see FIG. 5). On an upper surface of the roulette wheel 22, a plurality (38 in total in the present embodiment) of number pockets 23 in concave shape are formed. In addition, on an upper surface of the roulette wheel 22, number display plates 25 for displaying numbers are formed on an outer side of the number pockets 23 viewed from a rotation center axis 22A of the roulette wheel 22. On the number display plate 25, the number (“0”, “00”, “1” to “36”) that is assigned to the number pocket 23 adjacent to this number display plate 25 is shown.

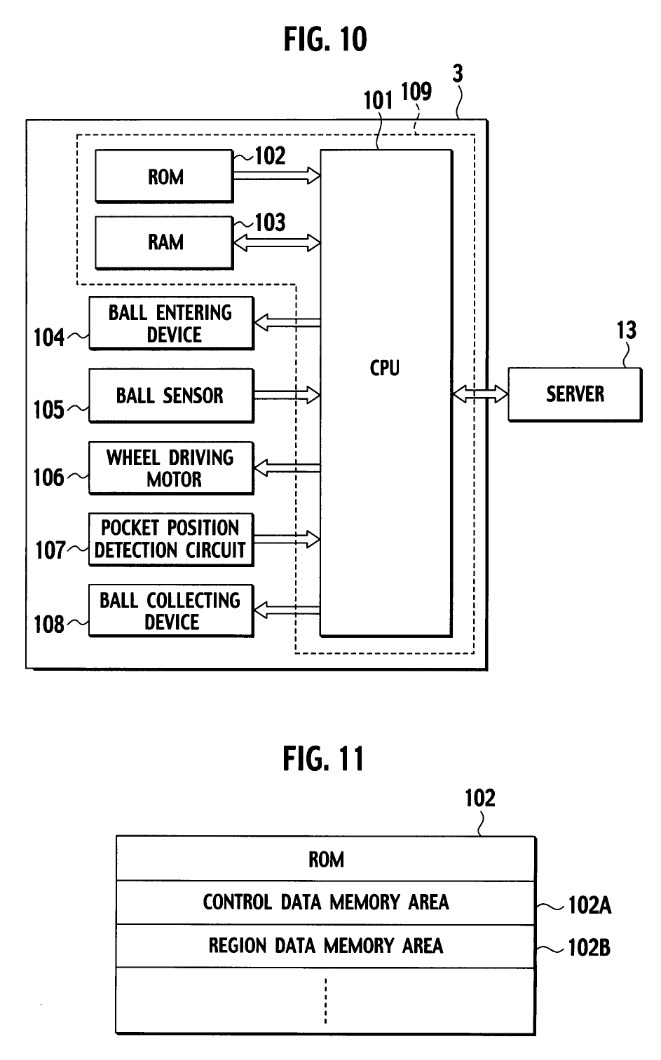

Inside the frame body 21, a ball entering hole 36 for entering a ball onto an upper surface of the roulette wheel 22 is provided. The ball entering hole 36 is connected to a ball entering device 104 (see FIG. 10) for entering a ball. The ball entering device 104 is a device for launching a ball into an upper surface of the roulette wheel 22, such that a ball is launched as this ball entering device 104 is activated, and the launched ball will be entered onto the roulette wheel 22 through the ball entering hole 36.

The roulette device 3 has its upper side covered by a hemispherical transparent acrylic cover 28 (see FIG. 5).

On a lower side of the roulette wheel 22, a wheel driving motor 106 (see FIG. 10) for rotating the roulette wheel 22 is provided. The roulette wheel 22 is rotated in conjunction with the activation of the wheel driving motor 106.

Also, on a lower side of the roulette wheel 22, metal plates (not shown) are attached at prescribed intervals. A pocket position detection circuit 107 (see FIG. 10) of the roulette device 3 detects a position of the number pocket 23 by detecting a metal plate using a metal sensor that is contained in the pocket position detection circuit 107.

The frame body 21 is gently inclined toward an inner side, and a guide wall 29 for guiding the ball is formed on its middle section. The guide wall 29 is for guiding the entered ball 27 against the centrifugal force. The entered ball 27 rolls down the slope of the frame body 21 toward the inner side as the rotational speed decreases and the centrifugal force becomes weaker, and falls on an upper surface of the rotating roulette wheel 22. Then, the ball that rolled onto the roulette wheel 22 further falls into one of the number pockets 23 by passing over the number display plates 25 of the rotating roulette wheel 22. Each number pocket 23 is provided with a ball sensor 105 (see FIG. 10) for detecting that the ball fell into it. A CPU 101 (see FIG. 10) of the roulette device 3 judges the number corresponding to the number pocket 23 into which the ball 27 fell, according to a result of the detection by the ball sensor 105. This judged number will be a winning number. This number is a number that is shown on the number display plate 25 adjacent to the number pocket 23.

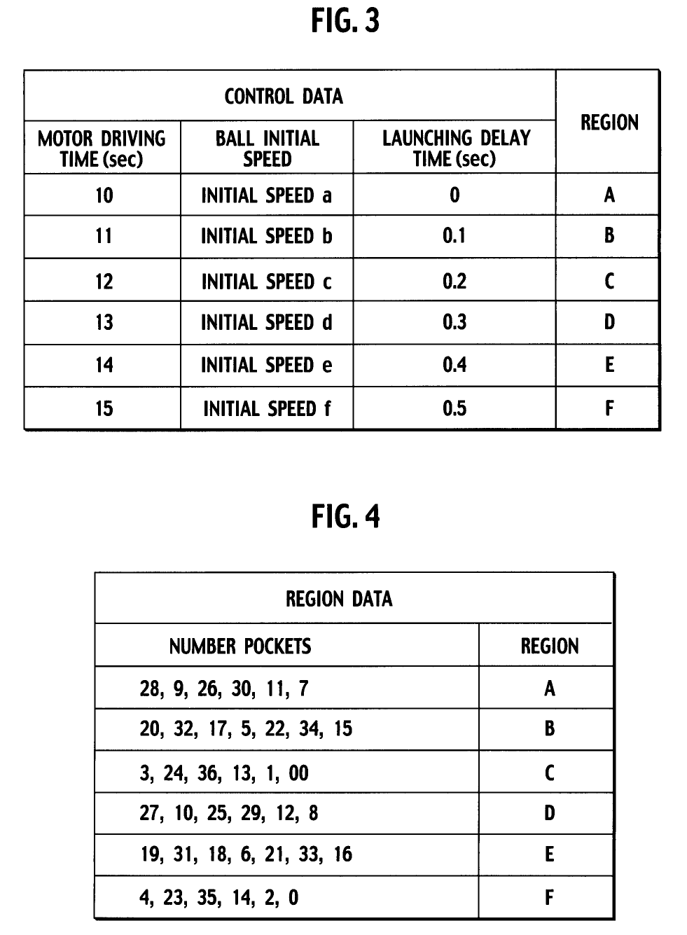

The rotation of the roulette wheel 22 and the launching of the ball 27 are carried out according to a control data. This control data is stored in a ROM 102 of a control unit 109 (to be described below) of the roulette device 3. FIG. 3 is a diagram showing one example of the control data.

As shown in FIG. 3, the control data contains a motor driving time, a ball initial speed, and a launching delay time.

The motor driving time is a time for activating the wheel driving motor 106 (see FIG. 10). The roulette wheel 22 is rotated at a prescribed rotational speed by the wheel driving motor 106 for a duration of the motor driving time. Note that after the activation of the wheel driving motor 106 is released, the -roulette wheel 22 will have a gradually decreasing rotational speed and eventually come to stop. The ball initial speed is an initial speed at a time of launching the ball 27 onto the roulette wheel 22 by the ball entering device 104. The launching delay time is a time since a prescribed number pocket 23 passes a prescribed position until the ball is launched while the roulette wheel 22 is rotated.

As shown in FIG. 2, the roulette wheel 22 is provided with a plurality of number pockets 23. Among these plurality of number pockets 23, one group is formed by neighboring six or seven number pockets 23. In this way, the plurality of number pockets 23 provided on the roulette wheel 22 are divided into six groups A to F. A plurality of number pockets 23 contained in one group are neighboring so that they form a certain region according to the number of the number pockets 23. In the following description, a “group” will be referred to as a “region”.

As shown in FIG. 3, each control data is set such that it becomes more likely for the ball 27 to fall into the number pockets 23 of one region among the regions A to F. For example, in the case where the rotation of the roulette wheel 22 and the launching of the ball 27 are controlled according to the control data of “the motor driving time 10 sec., the ball initial speed a, and the launching delay time 0”, a probability of the ball 27 to fall into any one of a plurality of number pockets 23 contained in the region A becomes higher. In the present embodiment, six control data are set in one-to-one correspondence with six regions A to F. These control data are stored in the ROM 102 (to be described below) of the roulette device 3. In the case of executing the roulette game, one of these plurality of control data is selected and the game proceeds according to this control data. In this way, it becomes more likely for the ball 27 to fall into the number pockets 23 contained in the region corresponding to this selected control data. In the following, the region corresponding to the selected control data will be referred to as a specific region, and also a plurality of number pockets 23 contained in this specific region will be referred to as specific number pockets.

Note that, as shown in FIG. 3, the control data is set in correspondence to a region into which the ball 27 becomes more likely to fall by that control data. Consequently, by specifying the region, the control data corresponding to that region can be specified. In FIG. 3, data indicating the regions A to F will be referred to as identification data. By the way, the control data may be set individually for each roulette device 3, or may be set commonly for all the roulette devices 3.

In the roulette device 3, one control data is selected and the roulette game proceeds according to this selected control data. Then, the sizes of the prizes generated at the specific region corresponding to the selected control data are accumulated, and when this accumulated value N reached to the threshold M, the control data that has been used until then is switched to another control data. Namely, according to the control data to be used, the ball 27 becomes more likely to fall into the number pockets 23 of the specific region, and when the accumulated value N of the sizes of the prizes generated at the number pockets 23 of this region reached to the threshold M, the control data to be used is switched to another control data. As a result, the specific region into which the ball 27 becomes more likely to fall is changed. This point will be described further below.

Also, as shown in FIG. 4, a correspondence table of the region and the number pockets 23 contained in that region is stored in the ROM 102 of the roulette device 3. Data indicating the number pockets 23 contained in the region will be referred to as region data. For example, in FIG. 4, the region data of the region A is data indicating the number pockets contained in this region A (the number pockets to which the numbers “28”, “9”, “26”, “30”, “11” and “7” are set in correspondence by the number display plates 25).

In the above described example, the case where each of the regions A to F is formed by neighboring six or seven number pockets 23 has been described, but the number of pockets belonging to one group is not particularly limited. Also, the number of pockets that constitute each group may be identical to each other or different.

Also, in the present embodiment, the case of dividing the number pockets 23 into six regions (groups) including the regions A to F has been described, but the number of regions is not limited to six.

In the above described example, the case where the regions A to F are not overlapping each other has been described. Namely, the case where the number pockets 23 belonging to one group do not belong to another group has been described. However, without being limited to this case, one pocket may be made to belong to a plurality of groups.

Also, in the above described example, the case where the control data is formed by the motor driving time, the ball initial speed and the launching delay time has been described, but the control data in the present invention is not limited to this case, and may be data containing at least one selected from data regarding a rotation control of the wheel (the motor driving time), data regarding a timing for launching the ball (the launching delay time), and data regarding an initial speed for launching the ball (the ball initial speed) or their combination. As the data regarding the rotation control of the wheel, it is possible to use the rotation speed of the roulette wheel at a time of the motor activation, for example, besides the motor driving time.

Next, the configuration of the roulette game machine 1 will be described.

As shown in FIG. 5, the roulette game machine 1 has a casing 2, a roulette device 3, a plurality of stations 4, and an electric light display unit 5. The casing 2 is a main body portion of the roulette game machine 1. The roulette device 3 is provided at an approximately center portion of an upper surface of the casing 2. The plurality of stations 4 (12 sets in the present embodiment) are arranged around the roulette device 3 such that they surrounds the roulette device 3. The electric light display unit 5 is provided on an upper side of the casing 2.

The station 4 has a medal insertion slot 6, a control unit 7, and an image display device 8. The medal insertion slot 6 is an insertion slot for at least inserting monetary values such as coins or gaming medium like chips or medals to be used for the gaming. The control unit 7 has a plurality of control buttons, such that various commands are inputted as the player operates the control buttons. The image display device 8 displays images related to the game. This image display device 8 has a touch panel on its display surface, which accepts the betting operation by the player. The player can proceed with the developing game by operating the touch panel and the control unit 7 while watching the images displayed on the image display device 8.

Also, on the side face of the casing 2 at which each station 4 is arranged, a medal payout opening 9 is provided respectively. In addition, on an upper right side of the image display device 8 of each station 4, a speaker 10 for outputting music, effect sounds and the like is provided.

On an upper side of the image display device 8 of each station 4, a WIN lamp 11 is provided respectively. In the case where the number (“0”, “00” and “1” to “36” in the present embodiment) bet at the station 4 in the game becomes the winning number, the WIN lamp 11 of the winning station 4 will be turned on. Also, in the JP bonus game for obtaining a special prize called jackpot (referred hereafter also as JP), the WIN lamp 11 of the station 4 that obtained JP will be turned on similarly. Note that this WIN lamp 11 provided at a position that is visible from all of the arranged stations 4 (12 sets in the present embodiment), such that the other players who are playing at the same roulette game machine 1 can always check which WIN lamp 11 is turned on.

Inside the medal insertion slot 6, a medal sensor (not shown) is provided. The medal sensor identifies the monetary values such as medals that are inserted at the medal insertion slot 6, and counts the inserted medals. Also, inside the medal payout opening 9, a hopper (not shown) is provided. The hopper pays a prescribed number of medals from the medal payout opening 9.

Inside a corner section 12 located at a corner of the casing 2, the server 13 is arranged. The server 13 is usually contained inside the corner section 12 such that it cannot be operated by the player, but the operation of the server 13 becomes possible when a corner door 14 provided at the corner section 12 is opened. The corner door 14 is opened by a key operation using a key switch. Then, when the server 13 is operated, various settings of the roulette game machine 1 are made by the server 13.

On the electric light display unit 5, a JP amount display unit 15 for displaying the amount of JP is provided. In the roulette game machine 1 according to the present embodiment, three types of JP including “MEGA”, “MAJOR” and “MINI” are provided as will be described below. In the case of JP “MEGA”, 0.15% of credits among credits that are bet in the game at all of 12 sets of the stations 4 will be accumulated and stored. In the case of JP “MAJOR”, 0.20% of credits among the credits that are bet will be accumulated and stored. In the case of JP “MINI”, 0.30% of credits among credits that are bet will be accumulated and stored. Then, in the case where any one of JP is won in the JP bonus game to be described below, credits corresponding to the accumulated amount that is accumulated for the corresponding JP will be paid to a prescribed station 4. The JP amount display unit 15 displays the accumulated amount for JP “MEGA” among three types of JP. Note that the JP amount display unit 15 is provided at a top of the electric light display unit 5, such that its display content is visible from all the players who are playing at the stations 4.

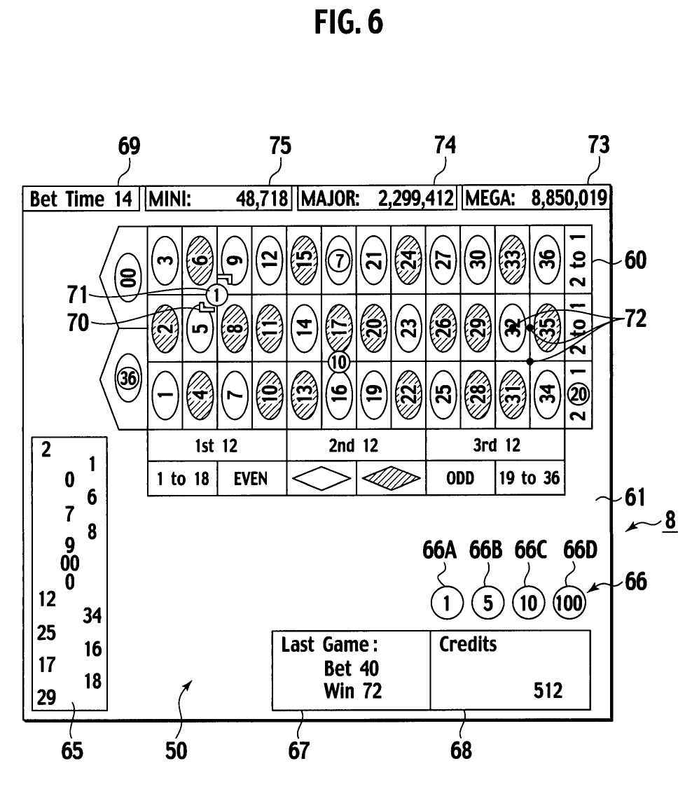

FIG. 6 shows one example of an image to be displayed on the image display device 8.

As shown in FIG. 6, during the game, a BET screen 61 having a table style betting board 60 is displayed on the image display device 8. The player bets chips by using his own credits, by operating a touch panel 50 provided on a front surface of the image display device 8.

First, the BET screen 61 to be displayed during the game will be described according to FIG. 6. On the table style betting board 60 displayed on the BET screen 61, 38 types of numbers “0”, “00” and “1” to “36” are arranged and displayed in lattice shaped grids. Also, special BET areas for betting chips by specifying “odd numbers”, “even numbers”, “a color of the number display plate (red or black)”, or “a range of numbers (“1” to “12”, for example)” are similarly arranged in lattice shaped grids.

On the lower side of the table style betting board 60, a result log display unit 65, unit BET buttons 66, a payout result display unit 67 and a credit amount display unit 68 are displayed.

The result log display unit 65 displays a list of the resulting winning numbers in the previous games (here, one game is a series of operations in which the players make bets at the stations 4, the ball 27 falls into the number pocket 23, and the payout of credit is made according to the winning number). At that time, when one game is finished, a new winning number is added from the above and displayed, and it is made possible to display the log of the winning numbers of at most 16 games.

Also, the unit BET buttons 66 are buttons for betting chips on a BET area 72 (on the grids of the numbers and the marks or on the lines forming grids) specified by the player. The unit BET buttons 66 comprise four types including a 1 BET button 66A, 5 BET buttons 66B, 10 BET button 66C, and 100 BET button 66D.

The player first sets up a cursor 70 to be described below within a screen by directly pressing the BET area 72 to be bet by a finger or the like, on the displayed screen, and specifies the area by this cursor 70. In that state, when the 1 BET button 66A is pressed, chips are bet in units of one chip (the number of bet chips is sequentially increased like 1, 2, 3 and so on, each time the 1 BET button 66A is pressed by the finger or the like). Also, when the 5 BET button 66B is pressed, chips are bet in units of five chips (the number of bet chips is sequentially increased like 5, 10, 15 and so on, each time the 5 BET button 66B is pressed by the finger or the like). Also, when the 10 BET button 66C is pressed, chips are bet in units of ten chips (the number of bet chips is sequentially increased like 10, 20, 30 and so on, each time the 10 BET button 66C is pressed by the finger or the like). Also, when the 100 BET button 66D is pressed, chips are bet in units of one hundred chips (the number of bet chips is sequentially increased like 100, 200, 300 and so on, each time the 100 BET button 66D is pressed by the finger or the like).

The payout result display unit 67 displays the number of chips bet by the player and the credit amount of the payout generated as a prize in the last game. Here, the number that can be obtained by subtracting the number of bet chips from the payout credit amount is the credit amount newly obtained by the player in the last game.

The credit amount display unit 68 displays the amount of credits currently owned by the player. This credit amount will be decreased according to the number of bet chips when the chips are bet (one credit for one bet). Also, when the bet chips win and the payout of credits is made, the credit amount will be increased as much as the payout credit amount. Note that when the credit amount owned by the player becomes zero, the game is over.

Also, on the upper portion of the table style betting board 60, a BET time display unit 69 is provided. The BET time display unit 69 displays a remaining time in which the players can bet, such that “20” will be displayed at a time of start accepting the betting operation, this number is decremented by one per each second, and the acceptance of the betting operation is finished when this number becomes “0”. Also, when the remaining time for betting by the player at each station 4 becomes five seconds, the ball entering device is activated and the ball 27 is entered onto the roulette wheel.

On the right side of the BET time display unit 69, a MEGA display unit 73 for displaying the credit amount accumulated until now for JP “MEGA”, a MAJOR display unit 74 for displaying the credit amount accumulated until now for JP “MAJOR”, and a MINI display unit 75 for displaying the credit amount accumulated until now for JP “MINI” are provided. The MEGA display unit 73 displays the accumulated 0.15% of credits among credits that are bet in each game at all of 12 sets of the stations 4. The MAJOR display unit 74 displays the accumulated 0.20% of credits among the credits that are bet. The MINI display unit 75 displays the accumulated 0.30% of credits among credits that are bet. The numerical values displays at the MEGA display unit 73, the MAJOR display unit 74 and the MINI display unit 75 are common numerical values for all the stations 4. In the case where JP is won by the JP bonus game, the credit amount for JP that is won among JPs displayed in the display units 73 to 75 will be paid, and the display unit for that JP after the payout will display a numerical value of the initial value (200 credits for “MINI”, 5000 credits for “MAJOR”, and 50000 credits for “MEGA”).

Also, on the table style betting board 60, the cursor 70 for indicating the BET area 72 currently selected by the player is displayed. Also, chip marks 71 for indicating the number of chips and the BET area 72 that are bet until that time are displayed. The number displayed on the chip mark 71 indicates the number of bet chips. For example, as shown in FIG. 6, the chip mark 71 of “7” placed on a grid “18” indicates that 7 chips are bet on the number “18”. Note that a method for betting on only one number in this way is a betting method called “straight bet”.

Also, the chip mark 71 of “1” placed at an intersection of grids “5”, “6”, “8” and “9” indicates that it covers four numbers of “5”, “6”, “8” and “9” and one chip is bet. Note that a method for betting that covers four numbers in this way is a betting method called “corner bet”.

The other betting methods include a “split bet” for covering two numbers by betting on a line between two numbers, a “street bet” for covering three numbers (“13”, “14” and “15”, for example) by betting at an edge of one row of numbers (one column in a vertical direction in FIG. 6), a “five bet” for covering five numbers “0”, “00”, “1”, “2” and “3” by betting on a line between “00” and “3”, a “line bet” for covering six numbers (“13”, “14”, “15”, “16”, “17” and “18”, for example) by betting between numbers of two rows (two columns in a vertical direction in FIG. 6), a “column bet” for covering 12 numbers by betting on a grid written as “2to1”, and a “dozen bet” for covering 12 numbers by betting on a grid written as “1st12”, “2nd12” or “3rd12”. In addition, there are a method for betting on the color of the number display plate (“red” or “black”), a method for betting on the odd numbers or the even numbers, and a method for covering 18 numbers by betting on the numbers less than or equal to 18 or the numbers greater than or equal to 19. Here, these plurality of betting methods have different payout amounts of credit per one chip (payout rates) when the bet chips win.

When the player makes the bet on the BET screen 61 in the above described configuration, the player first specifies the BET area 72 (on the grids of the numbers and the marks or on the lines forming grids) to be bet by directly pressing it on the screen by the finger. As a result, the cursor 70 is moved to the specified BET area 72.

After that, when the player presses each unit button (1 BET button 66A, 5 BET button 66B, 10 BET button 66C, 100 BET button 66D) of the unit BET buttons 66, the chips in that units will be bet on the specified BET area 72. For example, when the player presses the 10 BET button 66C four times, the 5 BET button 66B once, and 1 BET button 66A three times, the total 48 chips will be bet.

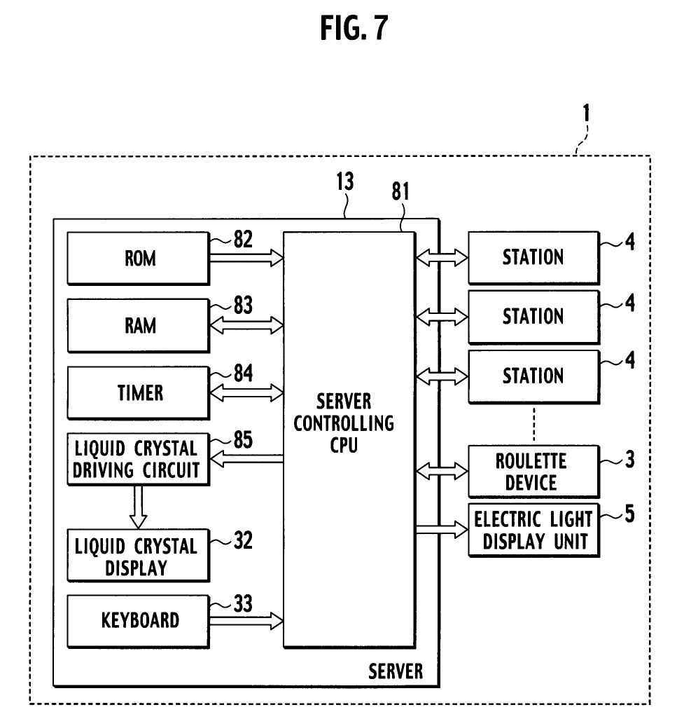

FIG. 7 is a block diagram showing an internal configuration of the roulette game machine according to the present embodiment.

As shown in FIG. 7, the roulette game machine 1 has the server 13 and a plurality (12 sets in the present embodiment) of the stations 4. The stations 4 are connected to the server 13. Also, the roulette device 3 and the electric light display unit 5 are connected to the server 13. Note that an internal configuration of the roulette device 3 and an internal configuration of the station 4 will be described in detail below.

The server 13 has a server controlling CPU 81, a ROM 82, a RAM 83, a timer 84, a liquid crystal display 32 and a keyboard 33. The server controlling CPU 81 carries out an overall control of the server 13. The liquid crystal display 32 is connected to the server controlling CPU 81 through a liquid crystal driving circuit 85.

The server controlling CPU 81 carries out various processings according to input signals supplied from each station 4, and data and programs stored in the ROM 82 and the RAM 83, and transmits command signals to the stations 4 according to the processing results. In this way, the server controlling CPU 81 controls each station 4 by its initiative. In particular, it transmits control signals to the roulette device 3, to control the launching of the ball 27 and the rotation of the roulette wheel 22.

The ROM 82 is formed by a semiconductor memory or the like, for example. This ROM 82 stores programs for realizing basic functions of the roulette game machine 1, programs for carrying out the notification of the maintenance timing, the setting of the content to be notified, etc., the payout rates with respect to the roulette game (the payout amount of credits with respect to the win per one chip), programs for controlling each station 4 by its initiative, etc.

On the other hand, the RAM 83 temporarily stores information regarding the specific region such as the accumulated value of the prizes (the amount of credits paid) generated according to the winning result in the specific region, the chip betting information supplied from each station 4, the winning number of the roulette device 3 judged by the sensors, the amount of JP accumulated until now, data regarding the result of the processing executed by the server controlling CPU 81, etc.

In addition, the timer 84 for measuring time is connected to the server controlling CPU 81. The time information of the timer 84 is transmitted to the server controlling CPU 81, and the server controlling CPU 81 carries out the control of the rotation operation of the roulette wheel 22 and the launching of the ball 27 as will be described below according to the time information of the timer 84.

Also, the electric light display unit 5 (see FIG. 5) is connected to the server controlling CPU 81. The server controlling CPU 81 realizes effects using the electric decoration by controlling the light emission by LED and the like with respect to the electric light display unit 5, and displays prescribed letters or the like on the electric light display unit 5. In addition, the server controlling CPU 81 makes the JP amount display unit 15 of the electric light display unit 5 in particular to display the amount of JP (JP “MEGA” in the present embodiment) accumulated until now.

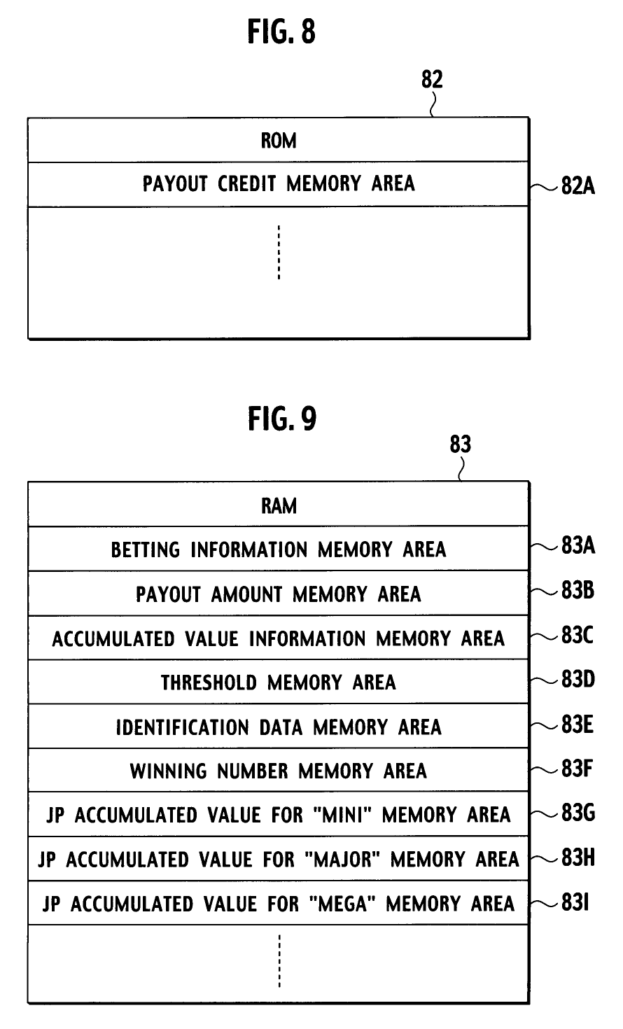

FIG. 8 is a schematic diagram showing the memory region of the ROM of the roulette game machine according to the present embodiment.

As shown in FIG. 8, in the ROM 82, a payout credit memory area 82A for storing the payout rates regarding the game is provided. Note that the payout rates with respect to the BET areas 72 of the BET screen 61 stored in the payout credit memory area 82A are determined in advance as rates of “×2” to “×36” depending on the types of the betting methods (”straight bet”, “corner bet”, “split bet”, etc.) and stored.

FIG. 9 is a schematic diagram showing the memory region of the RAM of the roulette game machine according to the present embodiment.

As shown in FIG. 9, in the ROM 83, abetting information memory area 83A, a payout amount memory area 83B, an accumulated value information memory area 83C, a threshold memory area 83D, an identification data memory area 83E, a winning number memory area 83F, a JP accumulated value for “MINI” memory area 83G, a JP accumulated value for “MAJOR” memory area 83H, and a JP accumulated value for “MEGA” memory area 83I are provided. The betting information memory area 83A stores the betting information of the currently playing player. The payout amount memory area 83B stores a total n of the payout amounts (credit amounts) in the specific region among the payout amounts (credit amounts) paid to all the stations 4 in one roulette game. The accumulated value information memory area 83C stores the accumulated value (the accumulated value of the payout amounts) N of the total n in one roulette game over a plurality of games. The threshold memory area 83D stores the threshold M to become a condition for switching the control data (FIG. 3). The identification data memory area 83E stores the identification data (data indicating any of the regions A to F) for specifying the control data (FIG. 3) that is currently used. The winning number memory area 83F stores the winning number of the roulette device 3 judged by the ball sensor 105. The JP accumulated value for “MINI” memory area 83G stores the credit amount accumulated for the JP “MINI”. The JP accumulated value for “MAJOR” memory area 83H stores the credit amount accumulated for the JP “MAJOR”. The JP accumulated value for “MEGA” memory area 83I stores the credit amount accumulated for the JP “MEGA”. Note that, more specifically, the betting information is information regarding the betting made by using the station 4, such as the BET area 72 (see FIG. 6) specified on the BET screen 61, the number of bet chips (bet number), the type of the betting method, etc.

FIG. 10 is a block diagram showing an internal configuration of the roulette device 3 according to the present embodiment. As shown in FIG. 10, the roulette device 3 has a control unit 109, a pocket position detection circuit 107, a ball entering device 104, a ball sensor 105, a wheel driving motor 106, and a ball collecting device 108. The control unit 109 corresponds to a controller of the present invention. Also, the ball sensor 105 corresponds to a detection unit for detecting a pocket into which the ball fell.

The control unit 109 has a CPU 101, a ROM 102, and a RAM 103. The CPU 101 controls the launching of the ball 27 and the rotation of the roulette wheel 22 according to the control signals supplied from the server 13, data stored in the ROM 102 and the RAM 103, and programs stored in the ROM 102 and the RAM 103.

FIG. 11 is a schematic diagram showing a memory region of the ROM of the roulette device according to the present embodiment.

As shown in FIG. 11, in the ROM 102, a control data memory area 102A is provided, and the control data described above with reference to FIG. 3 is stored.

The pocket position detection circuit 107 has a proximity sensor, and detects the position of the roulette wheel 22 (that is, the position of the number pocket 23), according to the presence/absence of the detection of the metal plate attached to the roulette wheel 22.

The ball entering device 104 is a device for entering the ball 27 onto the roulette wheel 22 from the ball entering hole 36 (see FIG. 2). The ball entering device 104 launches the ball 27 at the initial speed set in the control data, and enters this ball 27 onto the roulette wheel 22. Also, the ball entering device 104 launches the ball 27 at a timing according to the launching delay time set in the control data. Namely, after the launching delay time has elapsed since it is detected that a prescribed number pocket 23 (“00”, for example) has passed a prescribed position (a front of the ball entering hole 36, for example) by the pocket position detection circuit 107, the ball 27 will be launched.

The ball sensor 105 is a device for judging the number pocket 23 into which the ball 27 fell.

The wheel driving motor 106 is for for rotating the roulette wheel 22, and its activation is stopped after the motor driving time that is set in the control data has elapsed since the start of the activation.

The ball collecting device 108 is a device for collecting the ball 27 on the roulette wheel 22 after the game is over.

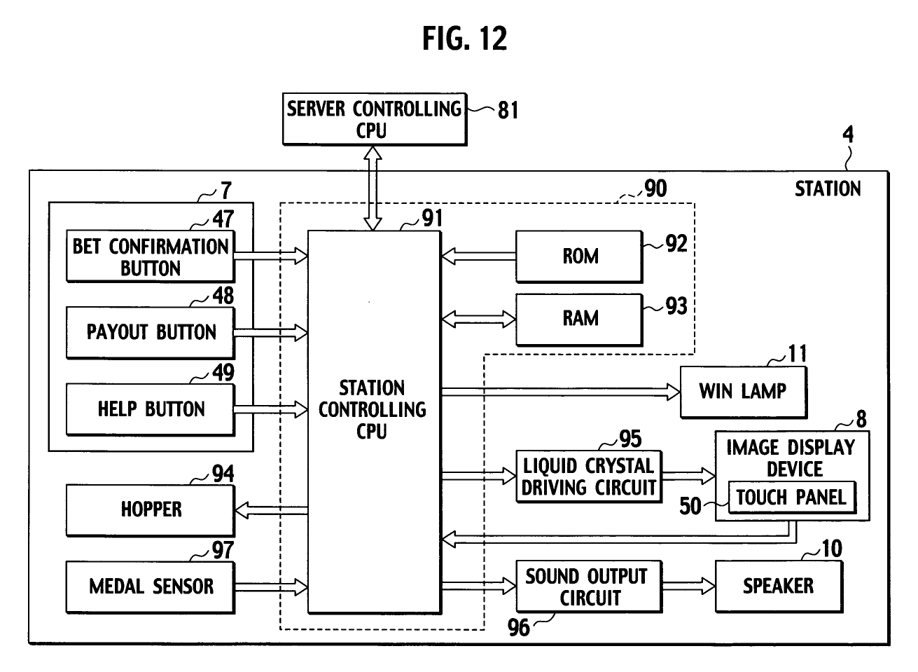

FIG. 12 is a block diagram showing an internal configuration of the station according to the present embodiment. Note that 12 sets of the stations 4 have basically the same configuration, and an example of one station 4 will be described in the following.

As shown in FIG. 12, the station 4 has a station control unit 90. The station control unit 90 has a station controlling CPU 91, a ROM 92 and a RAM 93. The ROM 92 is formed by a semiconductor memory or the like, for example, and stores programs for realizing basic functions of the station 4, and various programs, data table, etc., that are necessary for controlling the station 4. Also, the RAM 93 is a memory for temporarily storing various data calculated by the station controlling CPU 91, the amount of credits currently owned by the player (deposited at the station 4), the state of chip betting by the player, etc.

Also, a BET confirmation button 47, a payout button 48 and a help button 49 provided at the control unit 7 (see FIG. 5) are connected to the station controlling CPU 91.

The BET confirmation button 47 is a button to be pressed at a time of confirming the bet after the betting operation made by the image display device 8.

The payout button 48 is a button to be pressed usually when the game is over, and when the payout button 48 is pressed, the medals according to the credits currently owned by the player that have been obtained by the game or the like will be paid from the medal payout opening 9 (usually one medal for one credit)

The help button 49 is a button to be pressed when the operation method of the game or the like is unclear, and when the help button 49 is pressed, a help screen showing various operation information will be displayed on the image display device 8 immediately after that.

The station controlling CPU 91 carries out a control for executing various corresponding operations according to the operation signals outputted by the pressing of each button or the like. More specifically, various processings are executed according to the input signals supplied from the control unit 7 upon receiving the input of the player's operations, and data and programs stored in the ROM 92 and the RAM 93, and their results are transmitted to the server controlling CPU 81.

Also, the station controlling CPU 91 receives the command signals from the sever controlling CPU 81 and controls peripheral devices constituting the station 4, so as to proceed with the game at the station 4. Also, the station controlling CPU 91 executes various processings according to the input signals supplied from the control unit 7 upon receiving the input of the player's operations, and data and programs stored in the ROM 92 and the RAM 93, and controls the peripheral devices constituting the station 4 according to their results, so as to proceed with the game, depending on the processing content.

Also, a hopper 94 is connected to the station controlling CPU 91. The hopper 94 pays a prescribed number of medals from the medal payout opening 9 (see FIG. 5) according to the command signal from the station controlling CPU 91.

In addition, the image display device 8 is connected to the station controlling CPU 91 through a liquid crystal driving circuit 95. The liquid crystal driving circuit 95 has a program ROM, an image ROM, an image control CPU, a work RAM, VDP (Video Display Processor), and a video RAM. The program ROM stores an image controlling program and various selection tables regarding the display at the image display device 8. The image ROM stores dot data for forming an image to be displayed at the image display device 8, for example. The image control CPU makes the determination of an image to be displayed at the image display device 8 from the dot data stored in advance in the image ROM, according to the image control program stored in advance in the program ROM. The work RAM is provided as a temporary memory device at a time of executing the image control program at the image control CPU. The VDP forms an image according to the display content determined by the image control CPU and outputs it to the image display device 8. Note that the video RAM is provided as a temporary memory device at a time of forming an image by the VDP.

Also, on a front surface of the image display device 8, a touch panel 50 is attached as described above, and the operation information of the touch panel 50 is transmitted to the station controlling CPU 91. At the touch panel 50, the chip betting operation by the player is carried out on the BET screen 61. More specifically, the operation of the touch panel 50 is carried out in the selection of the BET area 72, the operation of the unit BET buttons 66, etc., and its information is transmitted to the station controlling CPU 91. Then, according to that information, the current betting information (the BET area and the number of bet chips specified on the BET screen 61) of the player is stored into the RAM 93 whenever necessary. In addition, this betting information is transmitted to the server controlling CPU 81, and stored in the betting information memory area of the RAM 83.

In addition, a sound output circuit 96 and a speaker 10 are connected to the station controlling CPU 91, and the speaker 10 generates various effect sounds at a time of making various effects according to the output signals from the sound output circuit 96.

Also, a medal sensor 97 is connected to the station controlling CPU 91. The medal sensor 97 detects medals inserted from the medal insertion slot 6 (see FIG. 5), and counts the inserted medals, and transmits its result to the station controlling CPU 91. The station controlling CPU 91 increases the amount of credits owned by the player that is stored in the RAM 93 according to the transmitted signal.

Also, a WIN lamp 11 is connected to the station controlling CPU 91. The station controlling CPU 91 turns on the WIN lamp 11 in a prescribed color, in the case where the chips bet on the BET screen 61 won or in the case where the JP is won.

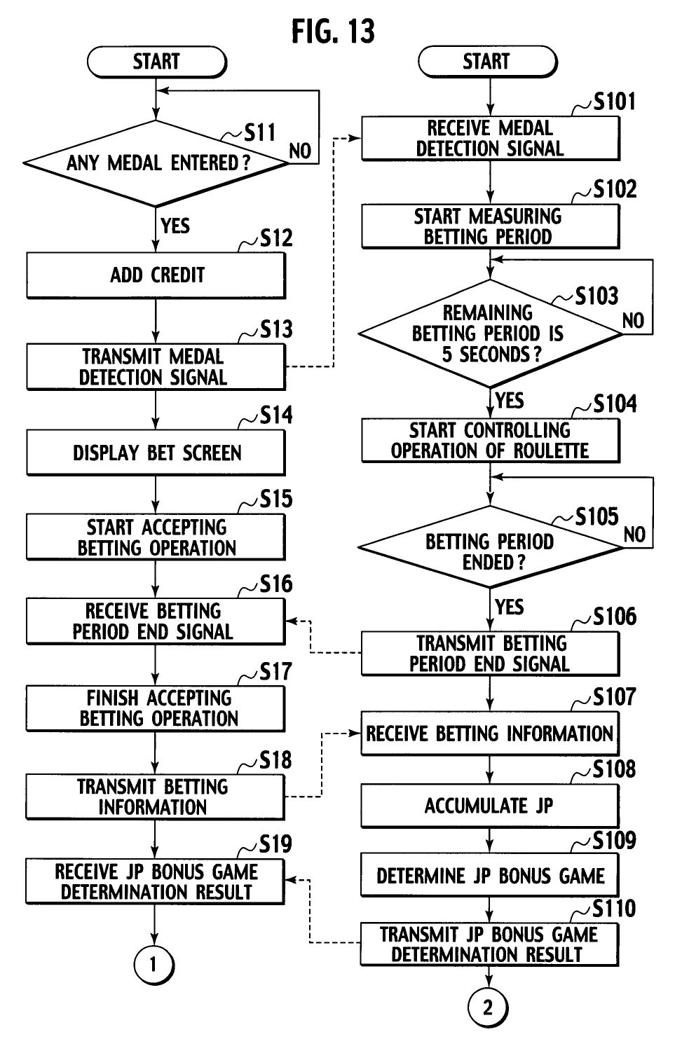

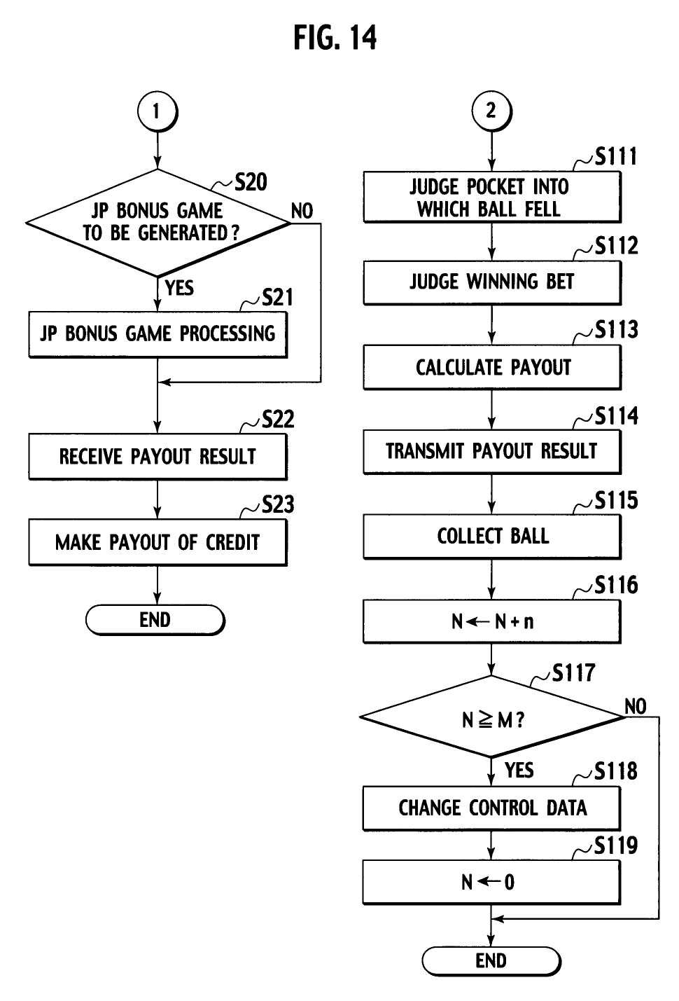

Next, the processing procedure on the server side to be executed by the server controlling CPU 81 of the roulette game machine 1 according to the present embodiment in proceeding with the game and the processing procedure on the station side to be executed by the station controlling CPU 91 will be described according to FIG. 13 and FIG. 14. FIG. 13 and FIG. 14 are flow charts showing the gaming processing for one roulette game in the roulette game machine according to the present embodiment. In the roulette game machine 1, this roulette game will be carried out repeatedly.

First, the gaming processing on the station side will be described according to FIG. 13 and FIG. 14.

First, at the step S11, the station controlling CPU 91 judges whether any medal or coin is entered by the player or not according to the detection signal of the medal sensor 97. In the case where the medal or coin is not entered (step S11 NO), the station controlling CPU 91 waits until it is entered, whereas in the case where the medal or coin is entered (step S11 YES), the processing proceeds to the step S12.

At the step S12, the station controlling CPU 91 stores the credit data of an amount corresponding to the entered medals or coins into the RAM 93. Next, at the step S13, the station controlling CPU 91 transmits a medal detection signal indicating that the medal or coin is entered, to the server 13.

Next, at the step S14, the station controlling CPU 91 displays the BET screen 61 shown in FIG. 6 on the image display device 8 of the station 4.

Next, at the step S15, the station controlling CPU 91 starts the measurement of the betting period during which the player can bet chips.

The player who is participating in the game bets his own chips on the BET area 72 related to the number of his own guess (see FIG. 6), by operating the touch panel 50 during this betting period in which the bet can be accepted. Note that the concrete betting method using the BET screen 61 has already been described above so that its description will be omitted here.

It is also possible for the player to participate in a middle of the game for which the betting period has already started, and in the roulette game machine 1 according to the present embodiment, at most 12 persons can play the game. In addition, in the case where the current game is to be carried in succession to the last game, the acceptance of the betting operation will start immediately after the last game is over.

Next, at the step S16, when the betting period end signal indicating that the betting period has ended from the server controlling CPU 81, the station controlling CPU 91 displays an image indicating that the betting period has ended on the image display device 8 of the station 4, and finishes accepting the betting operation by the touch panel 50 (step S17). After that, the station controlling CPU 91 transmits the betting information (the specified BET area 72 and the number of chips bet (BET number) on the specified BET area 72) of the bet made by the player at the station 4 (step S18).

Next, at the step S19, the station controlling CPU 91 receives a result of the processing for determining the JP bonus game to be described below which is executed by the server controlling CPU 81, from the server 13. The JP bonus game determination result contains the determination result regarding whether to generate a prescribed JP bonus game at each station 4 or not, and the determination result regarding which station 4 among 12 sets of the stations 4 should win the JP (or all the stations 4 should lose the JP) in the case of generating the JP bonus game, as well as which JP (“MEGA”, “MAJOR”, “MINI”) should be won in the case of having the JP won.

Next, at the step S20 of FIG. 14, the station controlling CPU 91 determines whether to generate the JP bonus game or not according to the result of the JP bonus game determination processing received at the step S19. In the case where it is determined that the JP bonus game is to be generated at this station 4, the JP bonus game of a prescribed selection type regarding the acquisition of the JP is executed, and its game result (whether the JP is acquired or not) is displayed on the image display device 8 according to the determination result received at the step S19 (step S21).

In the case where it is determined that the JP bonus game is not to be generated at this station 4 at the step S20, or after the processing of the step S21, the station controlling CPU 91 receives the credit payout result transmitted from the server controlling CPU 81 (step S22). Note that the credit payout result comprises the payout result of the game and the payout result of the JP by the JP bonus game.

Next, at the step S23, the station controlling CPU 91 makes the payout of credit according to the payout result received at the step S22. More specifically, the credit data of an amount corresponding to the payout of the game and the credit data of an amount corresponding to the payout of the JP accumulated until then in the case where the JP bonus game is generated and the JP is won at that station 4 are stored into the RAM 93. Then, when the payout button 48 is pressed, the medals corresponding to the credit amount stored in the RAM 93 (usually one medal for one credit) will be paid from the medal payout opening 9.

After that, in the case where the gaming is to be carried out continuously at any of the station 4, the station controlling CPU 91 returns the processing to the step S14, starts the betting period again, and make a shift to the next game. On the other hand, in the case where the gaming is to be finished at all the stations 4, the station controlling CPU 91 finishes the gaming processing.

Next, the gaming processing on the server side will be described according to FIG. 13 and FIG. 14.

First, at the step S101, the server controlling CPU 81 receives the medal detection signal transmitted from the station controlling CPU 91, and judges whether the medal or coin is entered by the player or not. In the roulette game machine 1 according to the present embodiment, when the medal or coin is entered at any of the stations 4, the medal detection signal is transmitted to the server controlling CPU 81 from the station controlling CPU 91 of the station 4 at which the medal or coin is entered.

Next, the server controlling CPU 81 starts the measurement of the betting period from a timing at which the medal or coin is entered by the first participating player (step S102). The betting period is a period during which the player can make bets. The player who is participating in the game can bet his own chips on the BET area 72 related to the number of his own guess by operating the touch panel 50 during this betting period.

Next, at the step S103, the server controlling CPU 81 judges whether the remaining betting period has become 5 seconds or not. Note that the remaining betting period is displayed on the BET time display unit 69 (see FIG. 6). In the case where it is judged that it has not reached the last 5 seconds, the server controlling CPU 81 returns the processing to the step S103. On the other hand, in the case where it is judged that it has reached the last 5 seconds, the server controlling CPU 81 proceeds the processing to the step S104.

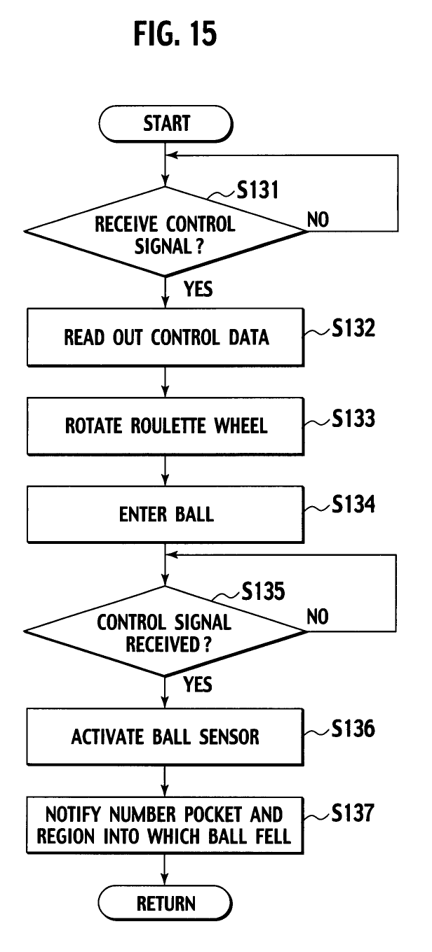

At the step S104, the server controlling CPU 81 transmits the control signal for starting the operation of the roulette device 3, to the CPU 101 of the roulette device 3. The CPU 101 that received this control signal controls the following operation by referring to the control data stored in the ROM 102. Note that the server controlling CPU 81 has selected one of the regions A to F as the specific region in advance and stored the identification data indicating that selected region (one of the regions A to F) in the identification data memory area 83E of the RAM 83. The server controlling CPU 81 reads out this identification data (data indicating one of the regions A to F), and transmits this identification data to the roulette device 3 by attaching it to the control signal. The CPU 101 of the roulette device 3 judges whether the control signal from the server 13 is received or not at the step S131 shown in FIG. 15, proceeds from the step S131 to the step S132 (FIG. 15) when it is received, and reads out the corresponding control data from the ROM 102 according to the identification data attached to the control signal.

The CPU 101 that read out the control data rotates the roulette wheel 22 by activating the wheel driving motor 106 only for the motor driving time that is set in this control data, at the step S133 (FIG. 15).

Next, after the rotation of the roulette wheel 22 is started and a prescribed period (20 seconds, for example) has elapsed, the CPU 101 proceeds to the step S134 (FIG. 15), and enters the ball 28 after the launching delay time has elapsed since the detection signal from the pocket position detection circuit 107 is detected. At this point, the ball is entered at the initial speed that is set in the control data.

Next, at the step S105 shown in FIG. 14, the server controlling CPU 81 judges whether the betting period has ended or not. In the case where it is judged that the betting period has not ended, it waits until the betting period ends.

On the other hand, in the case where it is judged that the betting period has ended, he server controlling CPU 81 transmits the betting period end signal indicating that the betting period has ended, to the station controlling CPU 91 (step S106).

Next, at the step S107, the server controlling CPU 81 receives the betting information (the specified BET area 72, the number of chips bet (BET number) on the specified BET area 72, and the betting method) of the bed made by the player at each station 4, from the station controlling CPU 91, and stores it into the betting information memory area 83A of the RAM 83.

Next, at the step S108, the server controlling CPU 81 accumulatively adds the credit corresponding to 0.30% of the total credits bet at the stations 4 that are received at the step S107, to the amount of JP recorded in the JP accumulated value for “MINI” memory area 83G of the RAM 83, and accumulatively adds the credit corresponding to 0.20% of the total credits to the amount of JP recorded in the JP accumulated value for “MAJOR” memory area 83H of the RAM 83. In addition, the server controlling CPU 81 accumulatively adds the credit corresponding to 0.15% of the total credits to the amount of JP recorded in the JP accumulated value for “MEGA” memory area 83I of the RAM 83. Also, the server controlling CPU 81 updates the display of the JP amount display unit 15, the MEGA display unit 73, the MAJOR display unit 74 and the MINI display unit 75, according to these JP amounts.

Next, at the step S109, the server controlling CPU 81 carries out the JP bonus game determination processing. In this processing, the server controlling CPU 81 determines whether to generate the JP bonus game at each station 4 or not, and which station 4 among 12 sets of the stations 4 should win the JP (or all the stations 4 should lose the JP) in the case of generating the JP bonus game, as well as which JP (“MEGA”, “MAJOR”, “MINI”) should be won in the case of having the JP won, by using a random number value sampled by a sampling circuit or the like.

Next, at the step S110, the server controlling CPU 81 transmits the JP bonus game determination result to each station 4, according to the processing of the step S109.

Next, at the step Sill, the server controlling CPU 81 activates the ball sensor 105 by transmitting the control signal to the roulette device 3, and judges which number pocket 23 corresponding to which number has the ball 27 fell into. In this case, the CPU 101 of the roulette device 3 judges whether the control signal from the server controlling CPU 81 is received or not, at the step S135 shown in FIG. 15, and proceeds from the step S135 to the step S136 (FIG. 15) when it is received. At this step S136, the CPU 101 activates the ball sensor 105, and further at the step S137, the CPU 101 notifies the data indicating the number pocket 23 into which the ball fell and the identification data indicating the region (one of the regions A to F) in which that number pocket 23 is contained, to the server controlling CPU 81. The region in which the number pocket 23 is contained is judged by the CPU 101 according to the region data stored in the region data memory area 102B of the ROM 102 (FIG. 11) of the roulette device 3.

Next, the server controlling CPU 81 judges whether the chips bet at each station 4 have won or not, from the betting information of each station 4 received at the step S107 of FIG. 14 and the number pocket 23 judged at the step S111 (step S112).

Next, at the step S113, the server controlling CPU 81 executes the payout calculation processing. In the payout calculation processing, the winning chips that are bet on the winning number are recognized for each station 4, and the total payout amount (credit amount) to be paid as a prize at each station 4 is calculated by using the payout rate (a credit amount to be paid per one chip (one bet)) with respect to each BET area 72 stored in the payout credit memory area 82A of the ROM 82.

Also, at the step S113, the server controlling CPU 81 calculates a total of sizes of prizes generated at the specific region in that roulette game. Namely, the server controlling CPU 81 calculates a total of sizes of prizes generated as the ball 27 fell into the number pocket 23 (specific number pocket) of the specific region (one of the regions A to F) in that roulette game. Here, the prize implies the payout amount (credit amount) to be paid. Consequently, a total of sizes of prizes generated at the specific region implies a total of the payout amount (credit amount) to be paid due to the winning in the specific region. As a procedure for calculating this total, the server controlling CPU 81 compares the identification data transmitted from the roulette device 3 at the step S137 of FIG. 15 with the identification data stored in the identification data memory area 83E of the RAM 83 (the identification data indicating the specific region that is set), and in the case where they coincide, the server controlling CPU 81 calculates the total n of the payout amounts generated at the specific region according to the information indicating the number pocket 23 notified from the roulette device 3 along with that identification data. In this way, it is possible to calculate the total n of the payout amounts generated at the number pocket 23 of the specific region into which the ball 27 is made to be more likely to fall by the control data. This total n is a total of the payout amounts generated at the specific region in one roulette game. Note that in the case where the payout amounts are generated at a plurality of stations 4, the total n of the payout amounts at all these stations 4 at which the payout amounts are generated will be calculated.

Then, at the processing of this step S113, the server controlling CPU 81 stores the calculated total n of the payout amounts into the payout amount memory area 83B of the RAM 83. Note that as this calculation (step S113) of the payout is carried out in each game, the total n stored in the payout amount memory area 83B of the RAM 83 will be updated in each game.

Next, at the step S114, the server controlling CPU 81 transmits the credit payout result of the game according to the result of the payout calculation of the step S113 and the JP payout result according to the JP bonus game determination processing of the step S109. More specifically, the credit data corresponding to the payout amount of the game is outputted and also the credit data corresponding to the currently accumulated JP amount is outputted in the case where the JP is won, with respect to the station controlling CPU 91 of the station 4 which won the game.

Next, at the step S115, the server controlling CPU 81 activates the ball collecting device 108 provided on a lower side of the roulette wheel 22 by transmitting the control signal to the roulette device 3, and collects the ball 27 on the roulette wheel 22. The collected ball 27 will be entered onto the roulette wheel 22 of the roulette device 3 again in the next and subsequent games.

Next, at the step S116, the server controlling CPU 81 reads out the total n of the payout amounts (credit amounts) calculated at the step S113 described above from the payout amount memory area 83B of the RAM 83, and reads out the accumulated value N of the total n (the accumulated value of the payout amounts generated at the specific region) from the accumulated value information memory area 83C of the RAM 83. Then, the read out total n is added to the read out accumulated value N and set that addition result as a new accumulated value N. Here, the accumulated value N implies the accumulated value of the payout amounts (credit amounts) generated at the specific region corresponding to the new control data, after the control data to be used (FIG. 3) is switched to another new control data. In other words, it implies the accumulated value of the payout amounts (credit amounts) generated at the switched specific region, after the specific region is switched to another region. Namely, the accumulated value N implies the accumulated value of the payout amounts generated at the specific region while the roulette game proceeds by using the identical control data (FIG. 3). The server controlling CPU 81 updates the accumulated value information in the accumulated value information memory area 83C by writing this updated accumulated value N into the accumulated value information memory area 83C of the RAM 83.

Next, at the step S117, the server controlling CPU 81 judges whether the accumulated value N updated at the step S116 described above becomes greater than or equal to the threshold M (M=1000 credits, for example) that is set in advance or not. This threshold M is stored in advance in the threshold memory area 83D of the RAM 83 of the server 13, and can be changed according to the need.

When the negative result is obtained at this step S117, this implies that the accumulated value N of the payout amounts (credit amounts) paid at the specific region after the control data is switched has not reached to the threshold M, so that the server controlling CPU 81 terminates this subroutine and proceeds to the next roulette game.

On the other hand, when the affirmative result is obtained at the step S117, this implies that the accumulated value N of the payout amounts (credit amounts) paid at the specific region after the control data is switched has reached to the threshold M, so that the server controlling CPU 81 proceeds from the step S117 to the step S118.

At the step S118, the server controlling CPU 81 switches the control data (FIG. 3) from the control data that has been used until then to another different control data. More specifically, the server controlling CPU 81 notifies the fact that the accumulated value N of credits has reached to the threshold M, along with the identification data indicating the control data that is used at that time, to the CPU 101 of the roulette device 3. The CPU 101 that received this notification carries out the sampling of a random number, and selects the control data that is different from the control data that is currently used, from a plurality of control data stored in the ROM 102, according to that acquired random number. Then, the CPU 101 transmits the identification data for specifying this selected control data to the server controlling CPU 81 of the server 13. The server controlling CPU 81 updates the identification data stored in the identification data memory area 83E by writing the received identification data into the identification data memory area 83E of the RAM 83. In this way, the game will proceed according to the updated control data, starting from the next game. Namely, starting from the next game, the game will proceed with the specific region changed.

Then, at the step S119, the server controlling CPU 81 resets the accumulated value N stored in the accumulated value information memory area 83C of the RAM 83 to zero. In this way, when the control data is switched, the accumulated value of the payout amounts (credit amounts) will be accumulated anew from zero, starting from the next roulette game. When the resetting of the accumulated value N is finished, the server controlling CPU 81 terminates this sub-routine, and proceeds to the next roulette game.

As described above, in the roulette game machine 1 of the present embodiment, all the number pockets 23 are divided into groups, by setting two or more number pockets that are consecutively arranged among a plurality of number pockets 23 as one group. Each group (region A to F) is set in one-to-one correspondence with the control data, respectively. The control data is data for making the probability of the ball 27 to fall into the number pockets 23 contained in the group that is set in correspondence to that control data higher. Consequently, in the roulette game machine 1, by using one of the control data at a time of proceeding with the roulette game, the probability of the ball 27 to fall into the number pockets 23 belonging to the region (specific region) that is set in correspondence to the control data to be used becomes higher.

Namely, in the roulette game machine 1, the CPU 101 selects one of a plurality of control data stored in the ROM 102, and proceeds with the roulette game according to this selected control data. In this roulette game, the ball 27 that is launched onto the roulette wheel 22 will fall into one of a plurality of number pockets 23 that are provided on the roulette wheel-22. In this case, the probability of the ball 27 to fall is made higher at the number pockets of the specific region corresponding to the control data to be used than at the other number pockets 23 among a plurality of number pockets 23, by the control using the control data.

Then, the total n of prizes generated at the specific region is calculated for each roulette game. This total n is the payout amounts (credit amounts) paid at all the stations 4 at which prizes are generated. Then, this total n is accumulated over the games. Here, in a series of roulette games using the identical control data, the number of times for which the ball 27 falls into the number pockets 23 of the specific region (one of the regions A to F) will increase as the number of games increases. This implies that the sizes of the prizes (payout amounts) generated at the specific region become larger as the number of games increases.

In the roulette game machine 1, in the case where the sizes of the prizes generated at the specific region reached to the threshold, by switching the control data to another control data so as to change the specific region, it is possible to prevent a situation in which the prizes this way, by changing the specific region, the sizes of the prizes generated at each region become uniform over all the regions as the number of games increases.

In the roulette game machine 1 according to the present embodiment, in a configuration for controlling the probability of having the ball 27 fell for each region, the specific region is maintained without being changed until the sizes of the prizes generated at the specific region reach to the threshold, and the specific region is switched when they reached to the threshold, so that it is possible to set a region into which the ball 28 is more likely to fall and make the sizes of the generated prizes uniform over all the regions at the same time.

Note that in the embodiment described above, the case of grouping a plurality of number pockets 23 together and providing the control data for each group has been described, but it is also possible to form one group by a single number pocket 23. In this case, the control data is data for making the ball more likely to fall into the corresponding number pocket 23. In this way, by setting the control data for each number pocket 23, it is possible to carry out a delicate control for each number pocket 23 at a time of proceeding with the roulette game.

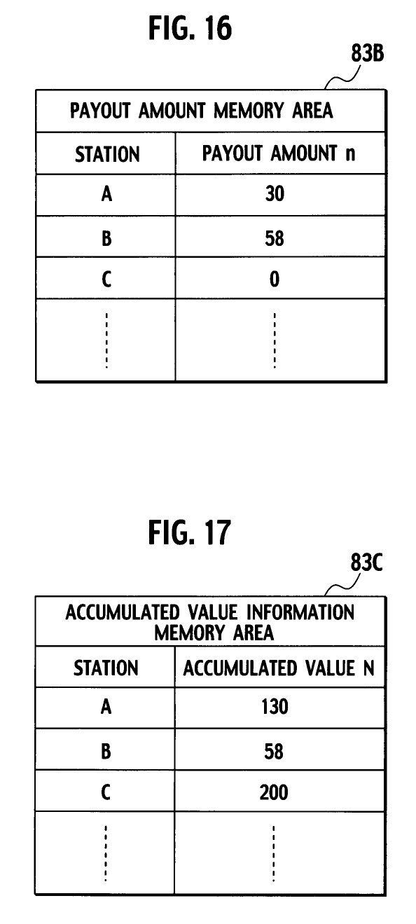

Also, in the embodiment described above, the case of switching the control data in the case where the accumulated value obtained as a total of the sizes of the prizes (payout amounts) generated at the specific region in all the stations 4 reached to the threshold has been described, but it is also possible to accumulate the sizes of the prizes generated at the specific region in each station 4, and switch the control data in the case where this accumulated value reached to the threshold. In this case, the server controlling CPU 81 calculates the total (payout amount) n of the payout amounts generated at the specific region in each station 4 at the step S113 shown in FIG. 14, and stores that calculation result into the payout amount memory area 83B of the RAM 83 by distinguishing each station 4 as shown in FIG. 16. Then, the server controlling CPU 81 calculates the accumulated value N for each station 4 by accumulating this total n of the payout amounts for each station 4 at the step S116. The accumulated value N for each station 4 calculated in this way is stored in the accumulated value information memory area 83C of the RAM 83 by distinguishing each station 4 as shown in FIG. 17. In the case where at least one of the accumulated values N stored for different stations 4 reached to the threshold N at the step S117, the server controlling CPU proceeds to the step S118 and changes the control data. In this way, the control data will be changed and in conjunction with that the specific region will also be changed, in the case where the accumulated value N of the payout amounts (prizes) generated at the specific region reached to the threshold M in at least one station among a plurality of stations 4.

What is claimed is:

1. A gaming apparatus comprising:
a roulette wheel having a plurality of pockets;
a device for launching a ball into the roulette wheel;
a detection unit for detecting a pocket into which the ball fell;
a controller operable to: (a) execute a first control for controlling such that a probability of having the ball fell into the pocket becomes relatively higher at a specific pocket among the plurality of pockets; and (b) execute a second control for accumulating sizes of prizes generated at the specific pocket among prizes generated according to a detection result of the detection unit, and changing the specific pocket to another pocket among the plurality of pockets in a case where that accumulated result reached to a threshold.

2. A gaming apparatus comprising:
a roulette wheel having a plurality of pockets;
a device for launching a ball into the roulette wheel;
a detection unit for detecting a pocket into which the ball fell;
a controller operable to: (a) execute a first control for controlling such that a probability of having the ball fell into the pocket becomes relatively higher at a specific group among a plurality of groups formed by dividing the plurality of pockets into groups of two or more pockets; and (b) execute a second control for accumulating sizes of prizes generated at the specific group among prizes generated according to a detection result of the detection unit, and changing the specific group to another group among the plurality of groups in a case where that accumulated result reached to a threshold.

3. A gaming apparatus comprising:
a roulette wheel having a plurality of pockets;
a device for launching a ball into the roulette wheel;
a detection unit for detecting a pocket into which the ball fell;
a controller operable to: (a) execute a first control for controlling such that a probability of having the ball fell into the pocket becomes relatively higher at a specific pocket among the plurality of pockets; (b) execute a processing for accepting a bet with respect to at least one pocket among the plurality of pockets by each player; and (c) execute a second control for accumulating sizes of prizes generated at the specific pocket among prizes generated according to a detection result of the detection unit and the bet of each player, and changing the specific pocket to another pocket among the plurality of pockets in a case where that accumulated result for at least one player reached to a threshold.

4. A gaming apparatus comprising:
a roulette wheel having a plurality of pockets;
a device for launching a ball into the roulette wheel;
a detection unit for detecting a pocket into which the ball fell;
a controller operable to: (a) execute a first control for controlling such that a probability of having the ball fell into the pocket becomes relatively higher at a specific group among a plurality of groups formed by dividing the plurality of pockets into groups of two or more pockets; (b) a processing for accepting a bet with respect to at least one pocket among the plurality of pockets by each player; and (c) a second control for accumulating sizes of prizes generated at the specific group among prizes generated according to a detection result of the detection unit and the bet of each player, and changing the specific group to another group among the plurality of groups in a case where that accumulated result for at least one player reached to a threshold.

5. A gaming apparatus comprising:
a roulette wheel having a plurality of pockets and supported to be freely rotatable;
a rotation driving unit for rotating the roulette wheel;
a device for launching a ball into the roulette wheel;
a detection unit for detecting a pocket into which the ball fell;
a controller operable to: (a) execute a first control for controlling such that a probability of having the ball fell into the pocket becomes relatively higher at a specific pocket among the plurality of pockets by controlling at least one selected from a speed of a rotation, a speed for launching the ball, and a timing for launching the ball; and (b) execute a second control for accumulating sizes of prizes generated at the specific pocket among prizes generated according to a detection result of the detection unit, and changing the specific pocket to another pocket among the plurality of pockets in a case where that accumulated result reached to a threshold.

6. A gaming apparatus comprising:
a roulette wheel having a plurality of pockets and supported to be freely rotatable;
a rotation driving unit for rotating the roulette wheel;
a device for launching a ball into the roulette wheel;
a detection unit for detecting a pocket into which the ball fell;
a controller operable to: (a) execute a first control for controlling such that a probability of having the ball fell into the pocket becomes relatively higher at a specific group among a plurality of groups formed by dividing the plurality of pockets into groups of two or more pockets by controlling at least one selected from a speed of a rotation, a speed for launching the ball, and a timing for launching the ball; and (b) execute a second control for accumulating sizes of prizes generated at the specific group among prizes generated according to a detection result of the detection unit, and changing the specific group to another group among the plurality of groups in a case where that accumulated result reached to a threshold.

7. A gaming apparatus comprising:
a roulette wheel having a plurality of pockets and supported to be freely rotatable;
a rotation driving unit for rotating the roulette wheel;
a device for launching a ball into the roulette wheel;
a detection unit for detecting a pocket into which the ball fell;
a controller operable to: (a) execute a first control for controlling such that a probability of having the ball fell into the pocket becomes relatively higher at a specific pocket among the plurality of pockets by controlling at least one selected from a speed of a rotation, a speed for launching the ball, and a timing for launching the ball; (b) execute a processing for accepting a bet with respect to at least one pocket among the plurality of pockets by each player; and (c) execute a second control for accumulating sizes of prizes generated at the specific pocket for each player among prizes generated according to a detection result of the detection unit and the bet of each player, and changing the specific pocket to another pocket among the plurality of pockets in a case where that accumulated result for at least one player reached to a threshold.

8. A gaming apparatus comprising:
a roulette wheel having a plurality of pockets and supported to be freely rotatable;
a rotation driving unit for rotating the roulette wheel;
a device for launching a ball into the roulette wheel;
a detection unit for detecting a pocket into which the ball fell;
a controller operable to: (a) execute a first control for controlling such that a probability of having the ball fell into the pocket becomes relatively higher at a specific group among a plurality of groups formed by dividing the plurality of pockets into groups of two or more pockets by controlling at least one selected from a speed of a rotation, a speed for launching the ball, and a timing for launching the ball; (b) execute a processing for accepting a bet with respect to at least one pocket among the plurality of pockets by each player; and (c) execute a second control for accumulating sizes of prizes generated at the specific group among prizes generated according to a detection result of the detection unit and the bet of each player, and changing the specific group to another group among the plurality of groups in a case where that accumulated result for at least one player reached to a threshold.

9. A playing method of a gaming apparatus, comprising the steps of:
proceeding with a roulette game in which a ball is launched into a roulette wheel provided with a plurality of pockets and a prize according to a pocket into which the ball fell is generated;
controlling such that a probability of having the ball fell into the pocket becomes relatively higher at a specific pocket among the plurality of pockets;
accumulating sizes of prizes generated at the specific pocket; and
changing the specific pocket to another pocket among the plurality of pockets in a case where that accumulated result reached to a threshold.

10. A playing method of a gaming apparatus, comprising the steps of:
proceeding with a roulette game in which a ball is launched into a roulette wheel provided with a plurality of pockets and a prize according to a pocket into which the ball fell is generated;
controlling such that a probability of having the ball fell into the pocket becomes relatively higher at a specific group among a plurality of groups formed by dividing the plurality of pockets into groups of two or more pockets;
accumulating sizes of prizes generated at the specific group; and
changing the specific group to another group among the plurality of groups in a case where that accumulated result reached to a threshold.

11. A playing method of a gaming apparatus, comprising the steps of:
proceeding with a roulette game in which a ball is launched into a roulette wheel provided with a plurality of pockets and a prize is generated on a condition that the ball fell into a pocket on which a bet is made in advance among the plurality of pockets;
controlling such that a probability of having the ball fell into the pocket becomes relatively higher at a specific pocket among the plurality of pockets;
accepting a bet with respect to at least one pocket among the plurality of pockets by each player;
accumulating sizes of prizes generated at the specific pocket; and
changing the specific pocket to another pocket among the plurality of pockets in a case where that accumulated result for at least one player reached to a threshold.

12. A playing method of a gaming apparatus, comprising the steps of:
proceeding with a roulette game in which a ball is launched into a roulette wheel provided with a plurality of pockets and a prize is generated on a condition that the ball fell into a pocket on which a bet is made in advance among the plurality of pockets;
controlling such that a probability of having the ball fell into the pocket becomes relatively higher at a specific group among a plurality of groups formed by dividing the plurality of pockets into groups of two or more pockets;
accepting a bet with respect to at least one pocket among the plurality of pockets by each player;
accumulating sizes of prizes generated at the specific group; and
changing the specific group to another group among the plurality of groups in a case where that accumulated result for at least one player reached to a threshold.

13. A playing method of a gaming apparatus, comprising the steps of:
proceeding with a roulette game in which a roulette wheel provided with a plurality of pockets is rotated while a ball is launched into the roulette wheel, and a prize according to a pocket into which the ball fell is generated;
controlling such that a probability of having the ball fell into the pocket becomes relatively higher at a specific pocket among the plurality of pockets by controlling at least one selected from a speed of a rotation, a speed for launching the ball, and a timing for launching the ball;
accumulating sizes of prizes generated at the specific pocket; and
changing the specific pocket to another pocket among the plurality of pockets in a case where that accumulated result reached to a threshold.

14. A playing method of a gaming apparatus, comprising the steps of:
proceeding with a roulette game in which a roulette wheel provided with a plurality of pockets is rotated while a ball is launched into the roulette wheel, and a prize according to a pocket into which the ball fell is generated;
controlling such that a probability of having the ball fell into the pocket becomes relatively higher at a specific group among a plurality of groups formed by dividing the plurality of pockets into groups of two or more pockets by controlling at least one selected from a speed of a rotation, a speed for launching the ball, and a timing for launching the ball;
accumulating sizes of prizes generated at the specific group; and
changing the specific group to another group among the plurality of groups in a case where that accumulated result reached to a threshold.

15. A playing method of a gaming apparatus, comprising the steps of:
proceeding with a roulette game in which a roulette wheel provided with a plurality of pockets is rotated while a ball is launched into the roulette wheel, a and a prize is generated on a condition that the ball fell into a pocket on which a bet is made in advance among the plurality of pockets;
controlling such that a probability of having the ball fell into the pocket becomes relatively higher at a specific pocket among the plurality of pockets by controlling at least one selected from a speed of a rotation, a speed for launching the ball, and a timing for launching the ball;
accepting a bet with respect to at least one pocket among the plurality of pockets by each player;
accumulating sizes of prizes generated at the specific pocket; and
changing the specific pocket to another pocket among the plurality of pockets in a case where that accumulated result for at least one player reached to a threshold.

16. A playing method of a gaming apparatus, comprising the steps of:
proceeding with a roulette game in which a roulette wheel provided with a plurality of pockets while a ball is launched into the roulette wheel, and a prize is generated on a condition that the ball fell into a pocket on which a bet is made in advance among the plurality of pockets;
controlling such that a probability of having the ball fell into the pocket becomes relatively higher at a specific group among a plurality of groups formed by dividing the plurality of pockets into groups of two or more pockets by controlling at least one selected from a speed of a rotation, a speed for launching the ball, and a timing for launching the ball;
accepting a bet with respect to at least one pocket among the plurality of pockets by each player;
accumulating sizes of prizes generated at the specific group; and
changing the specific group to another group among the plurality of groups in a case where that accumulated result for at least one player reached to a threshold.
